(19) United States
(12) Patent Application Publication
(10) Pub. No.: US 2016/0086281 A1
(43) Pub. Date: Mar. 24, 2016

(54) SYSTEM AND METHOD FOR PRESENTING ITEMS FOR SALE AND DIRECTING SALE PROCEEDS INTO A COLLEGE EDUCATION SAVING ACCOUNT

(71) Applicant: Jay A. Schmitt, Huntington, NY (US)

(72) Inventor: Jay A. Schmitt, Huntington, NY (US)

(21) Appl. No.: 14/957,009

(22) Filed: Dec. 2, 2015

Related U.S. Application Data
(63) Continuation-in-part of application No. 11/986,422, filed on Nov. 21, 2007.

(51) Int. Cl. G06Q 40/06; G06Q 20/38

(52) U.S. Cl. CPC G06Q 40/06; G06Q 20/38

(57) ABSTRACT

The disclosed technology relates to distributing proceeds from online sales into remote college education savings accounts. A virtual environment is provided that allows a seller to sell goods and a buyer to browse through the goods for purchase. Proceeds for a sale of the goods are received from a payment source associated with the buyer. The proceeds directly distributed into at least one remote college education savings account associated with the seller.

### CROSS-REFERENCE TO RELATED APPLICATIONS

This application is a continuation-in-part of U.S. patent application Ser. No. 11/986,422 entitled “METHOD AND SYSTEM FOR MANAGEMENT OF SELLING AND BUYING ITEMS” filed on Nov. 21, 2007.

### BACKGROUND

The disclosed technology generally relates to a system and method for presenting items for sale in a virtual environment and directing sale proceeds into tax-deferred, college education saving accounts.

Websites that provide online services and software for cataloging, auctioning, selling, buying goods and products are aplenty in the prior art. In these websites when good and products are sold the money is deposited in a seller's account held by the online service. The funds from this account are readily available to the seller but must be released by the online site before the seller can receive the funds.

### SUMMARY

The disclosed technology generally relates to a system and method for presenting items for sale in a virtual environment and directing sale proceeds into tax-deferred, college education saving accounts.

In one implementation, a method performed on a computer system for distributing proceeds from online sales into remote college education savings accounts, the method comprises: providing a virtual environment for a seller to sell goods and a buyer to browse through the goods for purchase; receiving proceeds for a sale of the goods from a payment source associated with the buyer, and distributing the proceeds directly into at least one remote college education savings account associated with the seller.

In some implementations, the remote college education savings accounts are affiliated with a financial institution. In some implementations, the proceeds can be divided as designated by the seller and put into two or more remote college education savings accounts. In some implementations, the method further comprises: providing a searchable database listing types of college education savings accounts.

In some implementations, the method further comprises: providing links to financial institutions that offer college education accounts. In some implementations, the method further comprises: providing incentives for opening college education accounts with certain financial institutions.

In another implementation, a method performed on a computer system for distributing proceeds from online sales into remote college education savings accounts, the method can comprise: providing a virtual environment for a seller to sell goods and a buyer to browse through the goods for purchase; receiving a purchase order and a payment source from a buyer; linking the payment source to at least one remote college education savings account associated with the seller; sending a note to a financial institution holding the at least one remote college education savings account that a payment of a certain sum is being sent for deposit into the at least one remote college education savings account; and receiving a confirmation from the financial institution that the certain sum has been received.

In some implementations, the method further comprises: sending a notification to the seller that the certain sum was deposited into the at least one remote college education savings account. In some implementations, the method further comprises: sending the goods to buyer. In some implementations, the method further comprises: receiving a confirmation from the buyer that goods were received.

### BRIEF DESCRIPTION OF THE DRAWINGS

The above mentioned and other features, aspects and advantages of the present invention will become better understood with regard to following description, appended claims and accompanying drawings, wherein like reference numerals refer to similar parts throughout the several views where:

FIG. 1 is a diagrammatic view of the a system in accordance with the present invention;

FIG. 2 is a flow chart for a method for opening an account, according to the present invention, implemented by the system in FIG. 1;

FIG. 3 is a flow chart of a method a buyer employs when searching and purchasing items, according to the present invention, implemented by the system in FIG. 1;

FIG. 4 is a flow chart of a method a buyer employs when editing account settings and managing items posted for sale, according to the present invention, implemented by the system in FIG. 1;

FIG. 5 shows display screen that welcomes a visitor when browsing;

FIG. 6 shows a display screen a user sees when a user edits the user details;

FIG. 7 shows a display screen a user sees when selecting a saving options;

FIG. 8 shows a display screen a user sees when selecting a financial institution, an insurance company, an investment group, a bank or the like for depositing a payment of money;

FIG. 9 shows a display screen a user sees when giving details of a designated account with the selected financial entity;

FIG. 10 shows a display screen a user sees when selecting a savings mix and a savings priority for the money that will be deposited;

FIGS. 11-13 show display screens as seen by a buyer when searching items for buying;

FIGS. 14-15 show display screens as seen by a buyer when making a payment to seller reference numbers;

FIGS. 16-19 show display screens as seen by a seller when editing account settings and managing items posted for sale;

FIG. 20 shows a flow chart illustrating an example of the disclosed technology;

FIG. 21 shows a flow chart illustrating an example of the disclosed technology; and

FIG. 22 shows a schematic diagram of an example of the disclosed technology.

### DETAILED DESCRIPTION

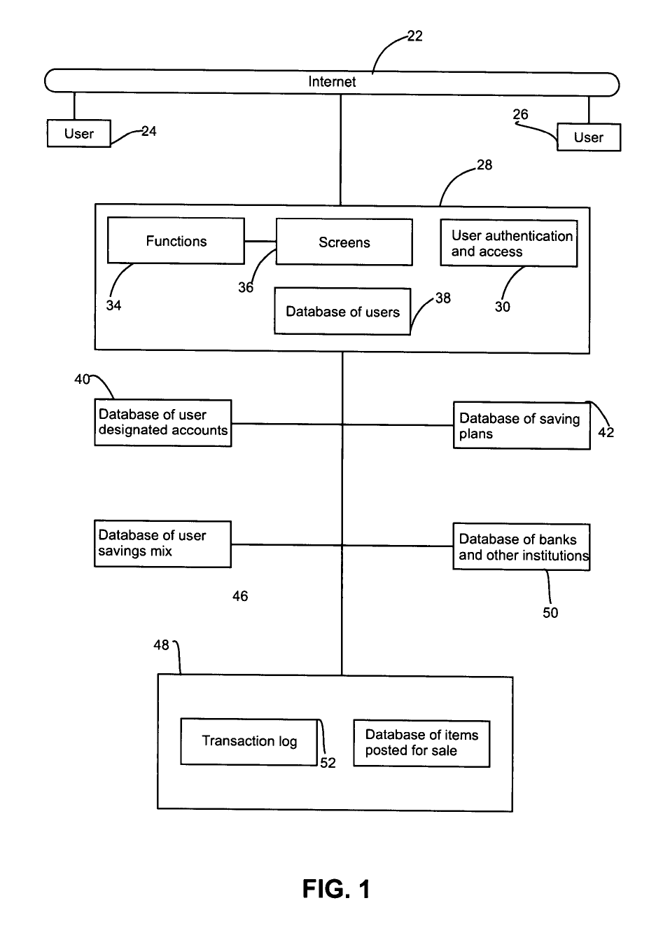

FIG. 1 shows a block diagram of an online system for management of selling items in lieu of savings options accordance with the present invention. A first server 28 is linked to the Internet 22 to service a number of users 24, 26. The first server 28 provides user authentication and access 30 to a number of other servers in a network 32. The first server 28 includes functions 34, screens 36, and a database of users 38. Functions 34 include various programs that facilitate user activities such as search, login, logout, making payment, adding and deleting details, for example. Files relating to user designated accounts, user saving plans, user saving mix, items posted by user for sale and files relating to associated banks and financial institutions are spread over servers 40, 42, 46, 48, 50 respectively. Server 48 also includes a transaction log 52 of items sold, bought and recalled.

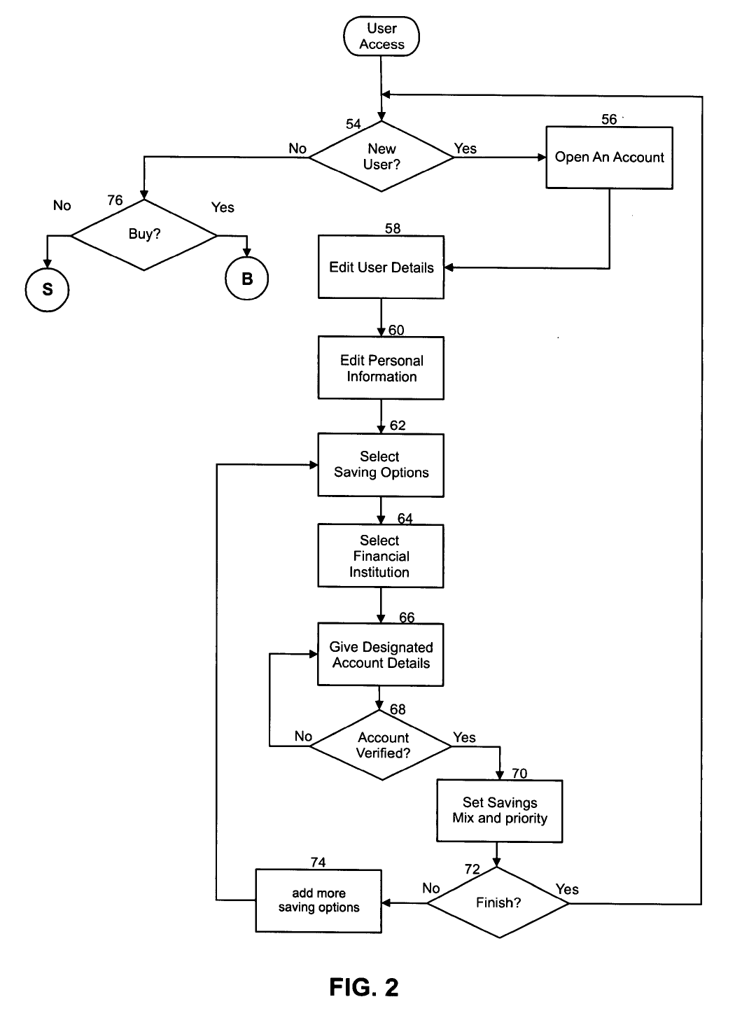

FIG. 2 shows a flowchart of a typical sequence of a user access when opening an account of the system implement in FIG. 1. The actual sequence of user access may vary from that shown in FIG. 2, because user may access various links, tabs and buttons that are available as desired and as needed.

In step 54 of FIG. 2, execution branches to step 56 if the user is new to the system. In steps 56, 58 and 60, the system registers the user, sets a default profile for the use and registers the user by receiving some information about the user, assigning a unique user id selected by the user, obtaining a password from the user, and creating a file for storing the user information and user profile. After steps 56, 58 and 60, execution continues to step 62.

In step 62, the user selects a saving option. Each saving option represents a class of financial entity associated with the system. Saving option is selected one at a time from a list of available classes. After step 62, execution continues to step 64.

In step 64, the user selects a financial entity enlisted in the class of financial entities or saving option selected in step 62. For example, the saving option can be banking and the user can select from a plurality of banking entities associated with the system. After step 64, execution continues to step 66.

In step 66, the user designates a pre-existing account with the financial entity selected in step 64 to the account being set up. The account can belong to the user or the user can nominate another person. For example, the user can nominate spouse, parents and children. The account is necessary for receiving payments from buyers that purchase user posted items for sale. After step 66, execution continues to step 68.

In step 68, the information about the designated account is sent for verification to the server of the selected financial entity. If the information is verified, the execution continues to step 70, else the execution goes back to step 64. The user is logged out of the system after a specified number of attempts at verifying the designated account information fail.

In step 70, the user sets savings mix and savings priority. The use can decide the share of each saving option or each class of financial entity out of total savings deposited in a user account. For example, a user can set the banking saving option to receive 50% and the insurance saving option to receive 50% of the total payments made by buyers.

The use can also prioritize saving options that are selected to receive the payment. For example, the user can give the first priority banking saving option to receive payments, and so on and so forth. After step 70, the execution continues to step 72.

In step 72, the execution branches to step 54 if the user wants to finish setting up his account, else the execution branches to step 62 so that the user can add more saving options.

In step 54 of FIG. 2, execution branches to step 56 if the user is new to the system. The execution branches to step 76 if the user is already registered and not new to the system.

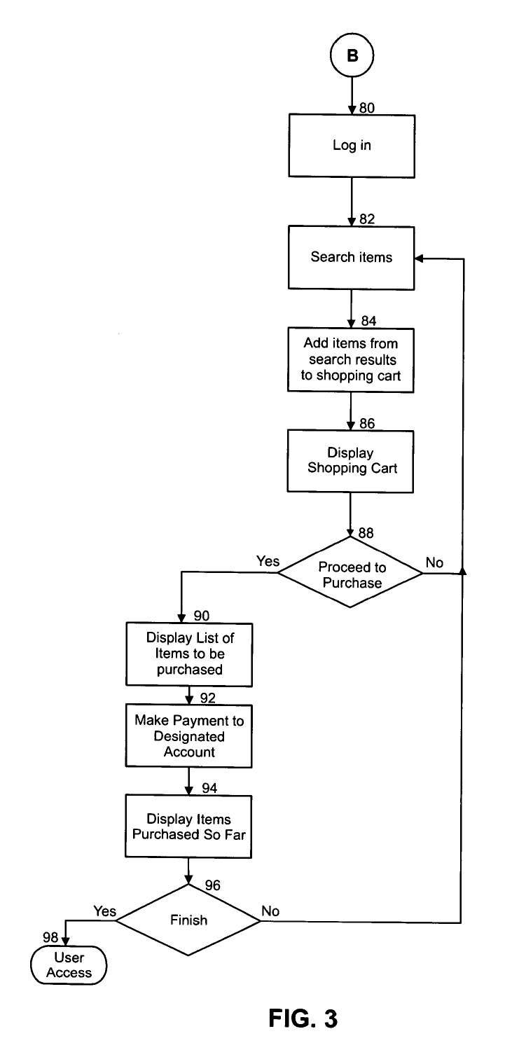

Execution branches to step 78 of FIG. 3, if the user wants to buy items posted for sale. In next step 80, the user enters username and password to log in. The successful execution of step 80 leads to step 82. In step 82, the user searches the system for items posted for sale using keyword search. The user can also use categories and subcategories to refine the search. After step 82, the execution continues to step 84.

In step 84, the user selects items from search results and adds them to shopping cart. After step 84, the execution continues to step 86. In step 86, the items that are added to the shopping cart are displayed. After step 86, the execution continues to step 88. In step 88, the execution branches to step 82 if the user does not want to continue with purchasing the items in the shopping cart.

The execution branches to step 90 if the user wants to proceed with purchasing of items in the shopping cart. In step 90, the user selects items to be purchased from the items in the shopping cart and the execution continues to step 92. In step 92, the user makes payment to designated accounts of sellers and execution continues to step 94 that displays items purchased so far by the user. After step 94, the step continues to step 96. In step 96, the execution branches to step 98 that takes user to system user access. The execution branches to step if the user wants to continue searching for items posted for sale.

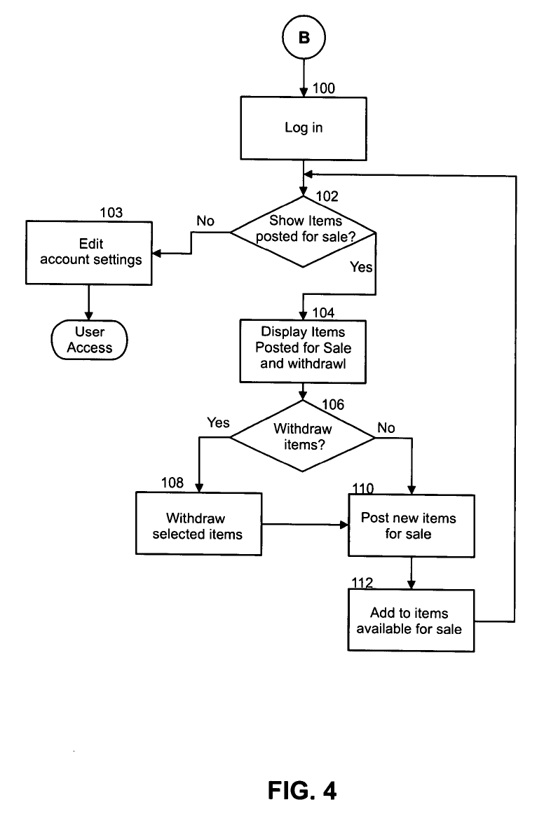

Execution branches to step 100 shown in FIG. 4, if the user wants to post items for sale. In step 100, the user logs in entering his username and password and the execution continues to step 102. In step 102, the execution branches to step 103 if the user does not want to be shown a display items posted for sale. In step 103, the user edits his account settings and the execution continues to user access.

In step 102, the execution branches to step 104 if the user wants to be shown a display of items posted for sale by the user. In step 104, the user gets a display of items of posted. In step 104, the items that the user wants to withdraw can also be selected. After the step 104, the execution continues to step 106.

In step 106, the execution branches to 108 if the user wants to withdraw items selected in step 104. In step 108, the items selected are deleted from items posted for sale and execution continues to step 110.

In step 106, the execution branches to 110, if the user does not want to withdraw posted items. In step 110, the user posts new items for sale and the execution continues to step 112. In step 112, new items posted are added to items posted for sale and the execution continues to step 102.

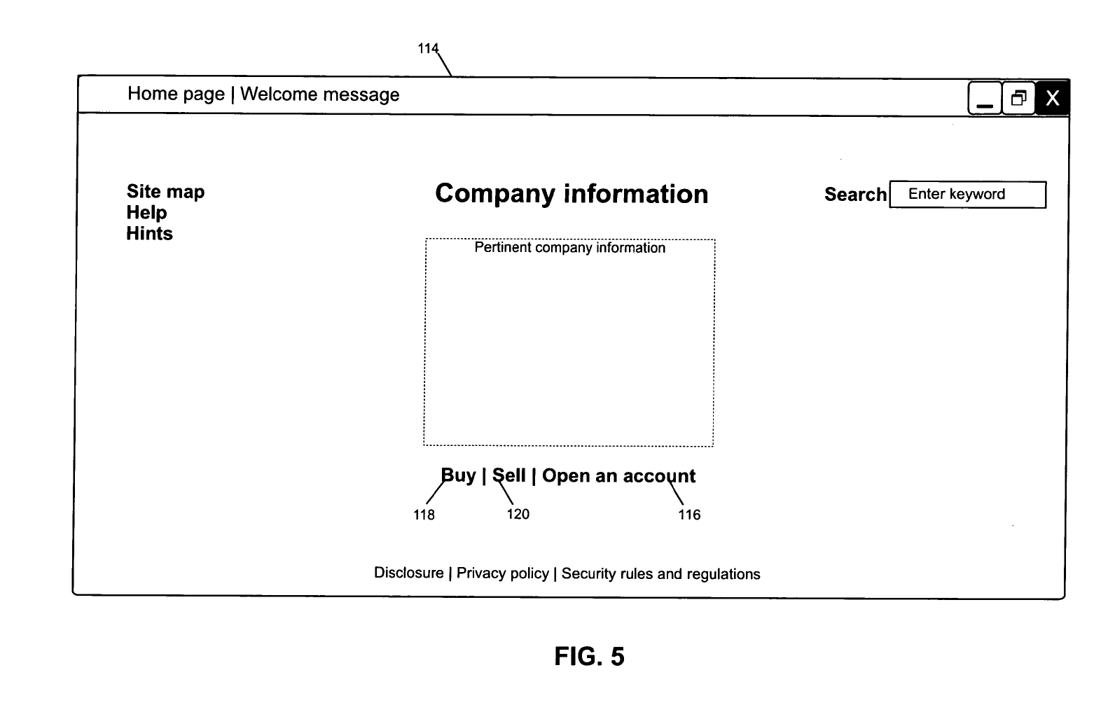

Referring now to FIGS. 5-10, the steps involved in opening and setting up a user account are explained. FIG. 5 illustrates a display screen 114 entitled “Home page | Welcome message” where a user may open account by clicking a button 116 designated as “Open an account.” The user may proceed to buy by clicking a button 118 designated as “Buy” and the user may proceed to sell by clicking a button 120 designated as “Sell.”

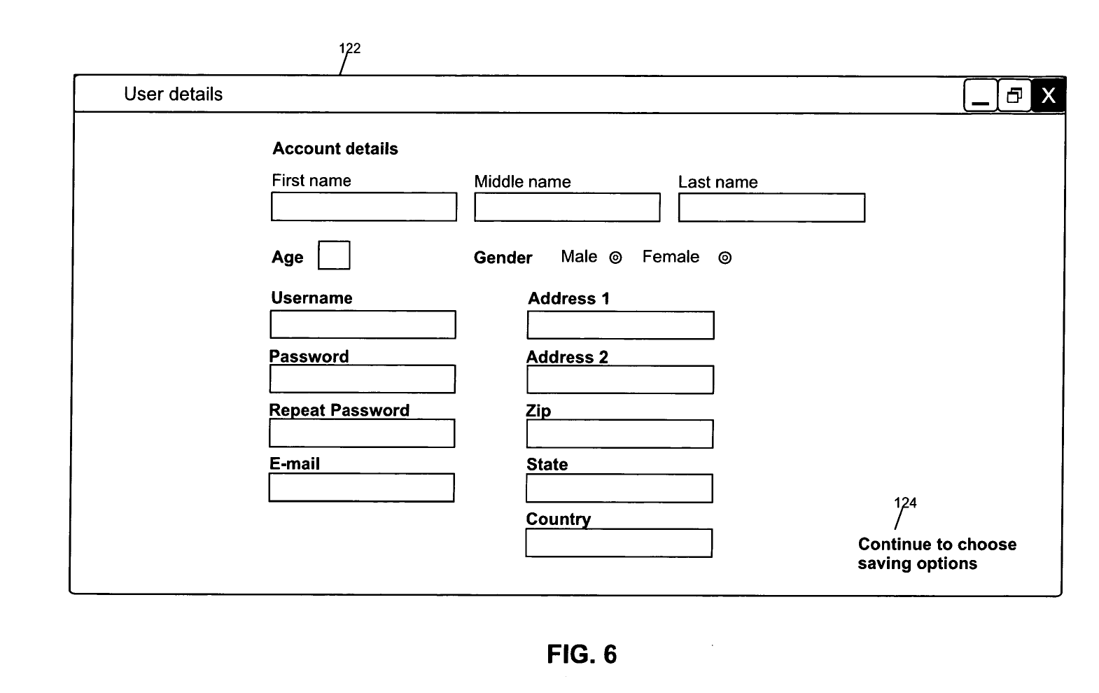

FIG. 6 illustrates a display screen 122 entitled “User details” that is generated upon clicking “Open an account” button 116 where the user may submit account details, username and password, and so on so forth. The user may proceed to choosing saving options by clicking a button 124 designated as “Continue to choose saving options.”

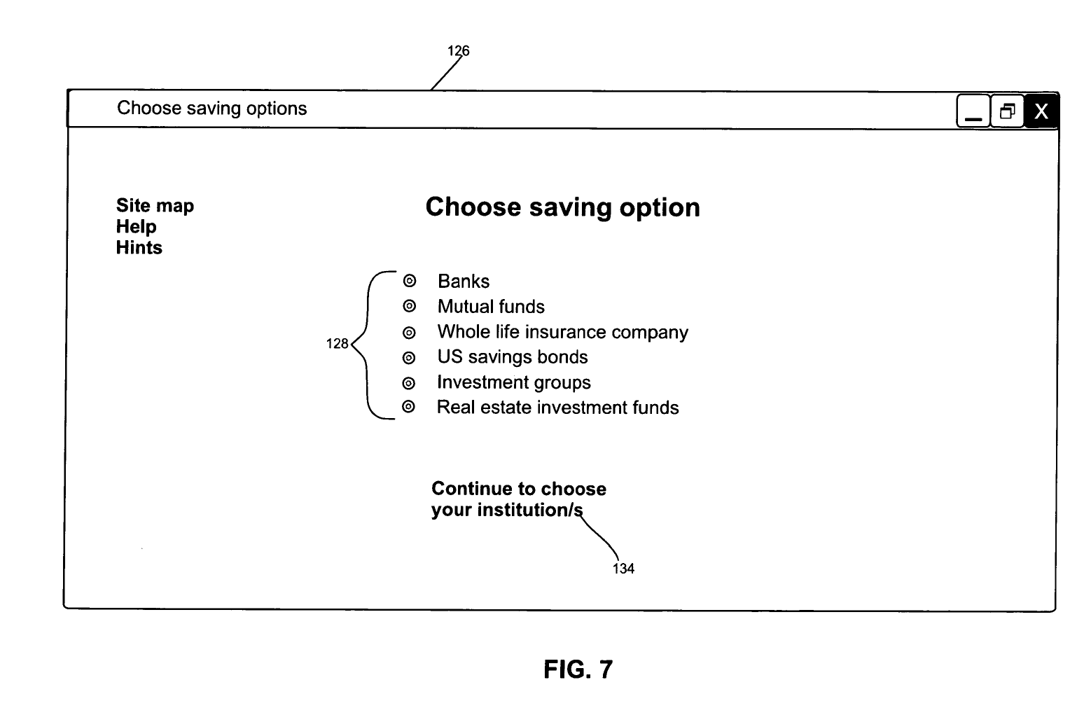

FIG. 7 illustrates a display screen 126 entitled “Choose saving options” that is generated upon clicking button 124 where a user may choose a savings option from a list of radio buttons. The enlisted savings options include options 128 such as, but not limited to, banks, mutual funds, whole life insurance, US savings bonds, investment groups, real estate investment funds, for example. The user may proceed to choosing a financial institution belonging to the savings option category selected by clicking a button 134 designated as “Continue to choose your institutions.”

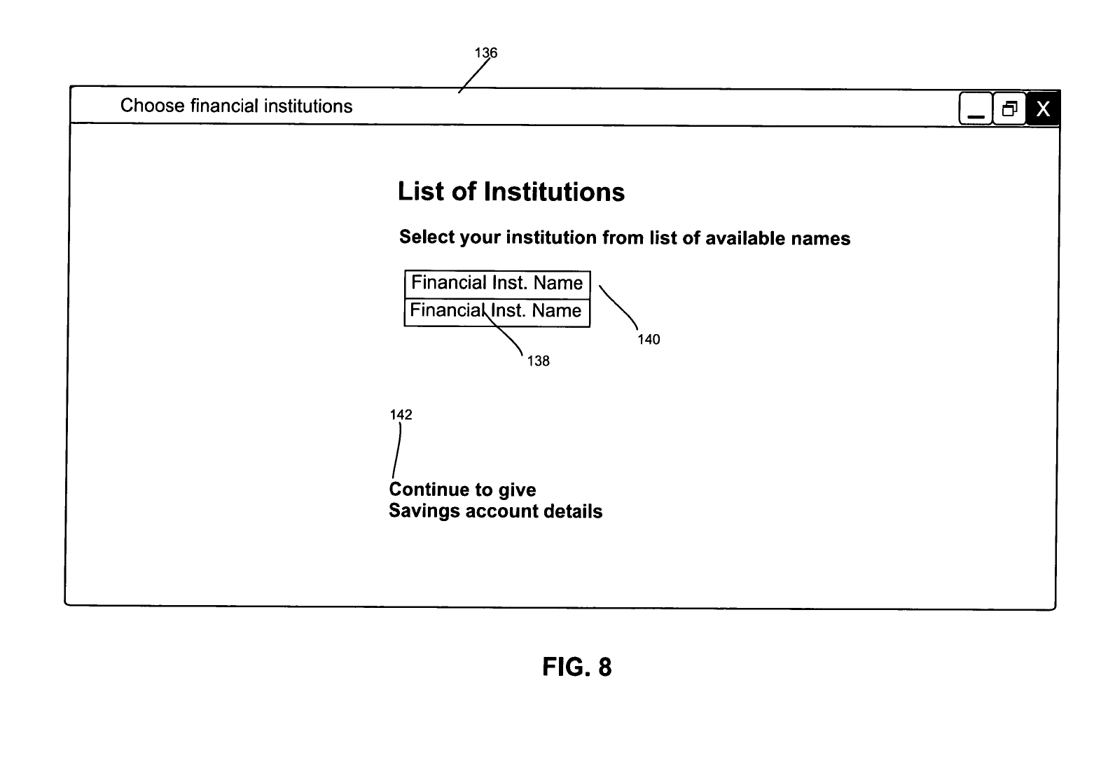

FIG. 8 illustrates a display screen 136 entitled “Choose financial institutions” that is generated upon clicking button 134 where the user may choose financial institution 138 belonging to the saving option selected earlier from a drop down list 140 labeled “Select your institutions from list of available names.” The user may proceed to give further details by clicking a button 142 designated as “Continue to give savings account details.”

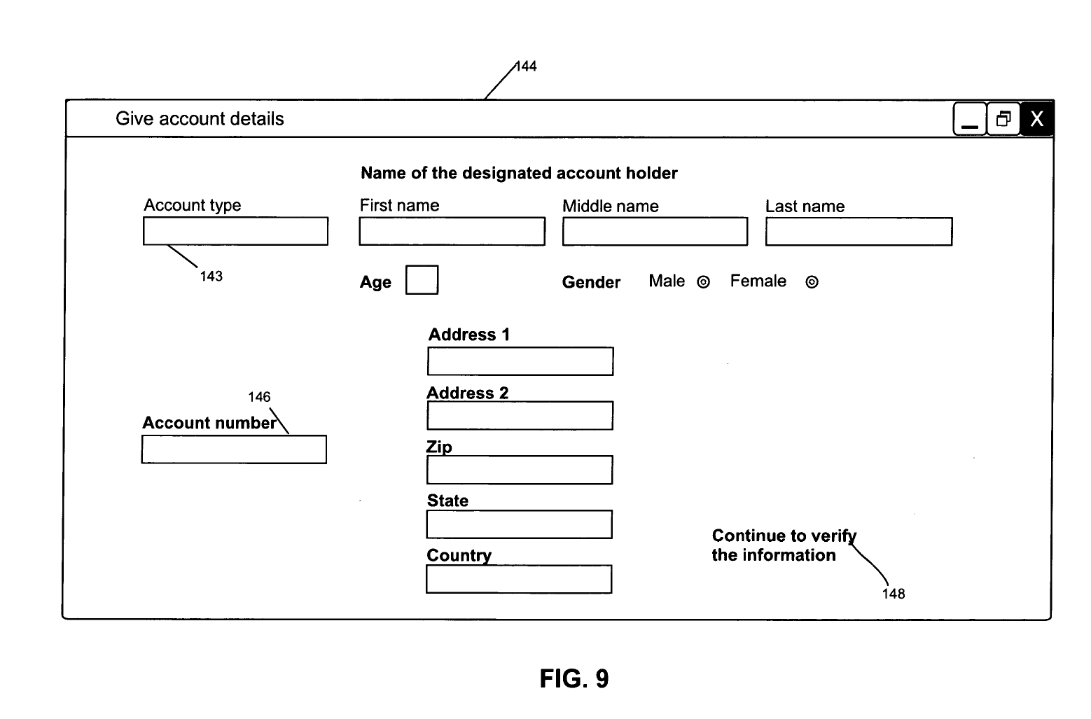

FIG. 9 illustrates a display screen 144 entitled “Give your account details” that is generated upon clicking button 142 where user may give details about the account a pre-existing account belonging to financial institution 138 belong the saving option selected. This is the account where the payment made by a seller will be deposited. The user submits details such as, account type 143, account number 146 and other important details. The user may proceed to get all the information verified by clicking a button 148 designated as “Continue to verify the information.”

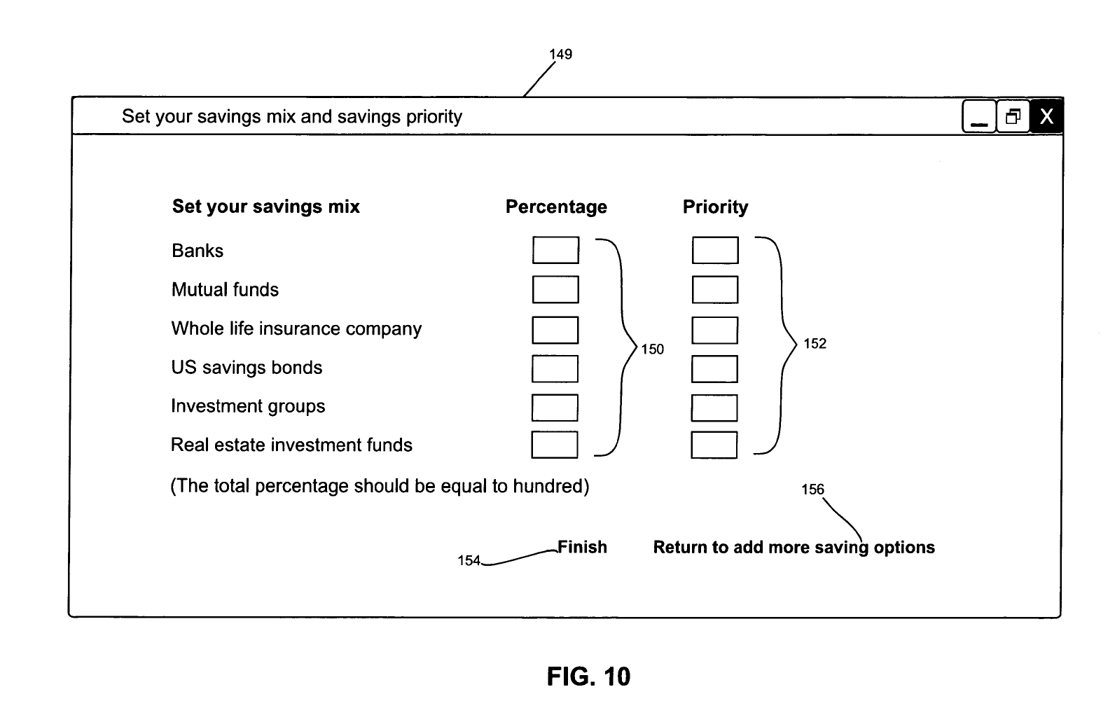

FIG. 10 illustrates a display screen 149 entitled “Set your savings mix and savings priority” that is generated upon clicking button 148 where user may set his savings mix 150 and savings priority 152. Savings mix 154 is defined the total composite of saving options selected by user. The user can customize the savings mix 150 by setting the percentage share of each chosen savings option. The user can also set savings priority 152 by giving the priority number to each savings option. The savings option with highest priority number will have the highest priority when a payment is made to the account of user and so on and so forth. The user may proceed to return to home page by clicking a button 154 designated as “Finish” or may proceed to add more savings options by clicking a button 156 designated as “Return to add more saving options.”

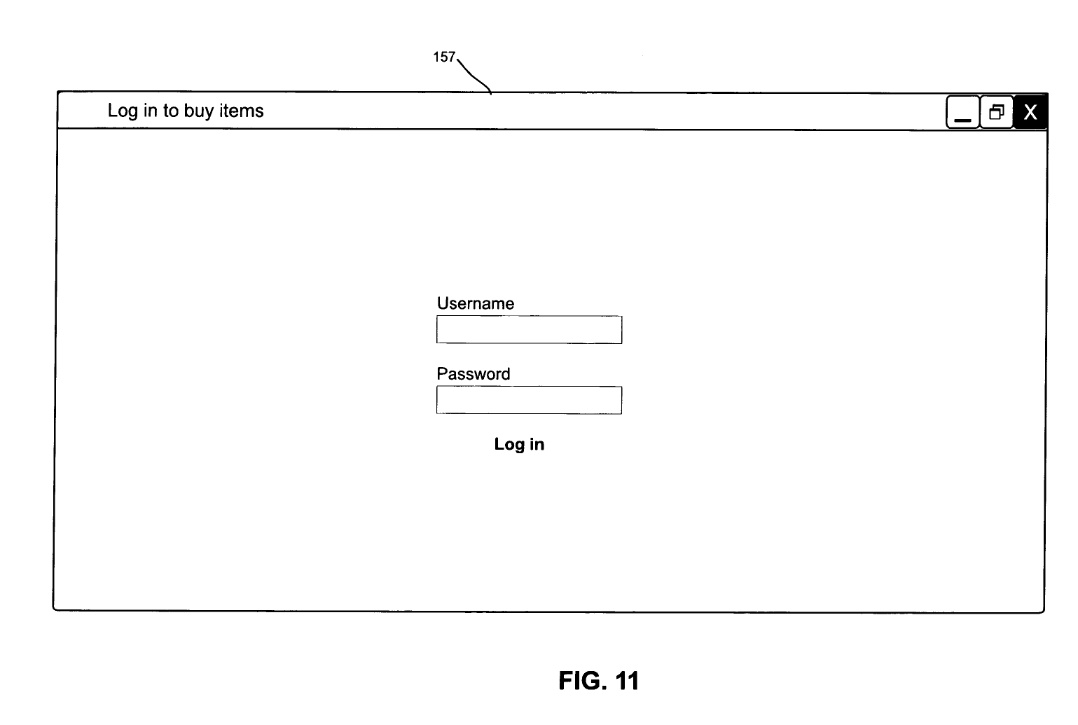

Referring now to FIGS. 11-15, the steps involved in buying an item posted for sale is explained. FIG. 11 illustrates a display screen entitled “Log in to buy items” where the user enters his username and password. The user proceeds to search items for on successfully logging.

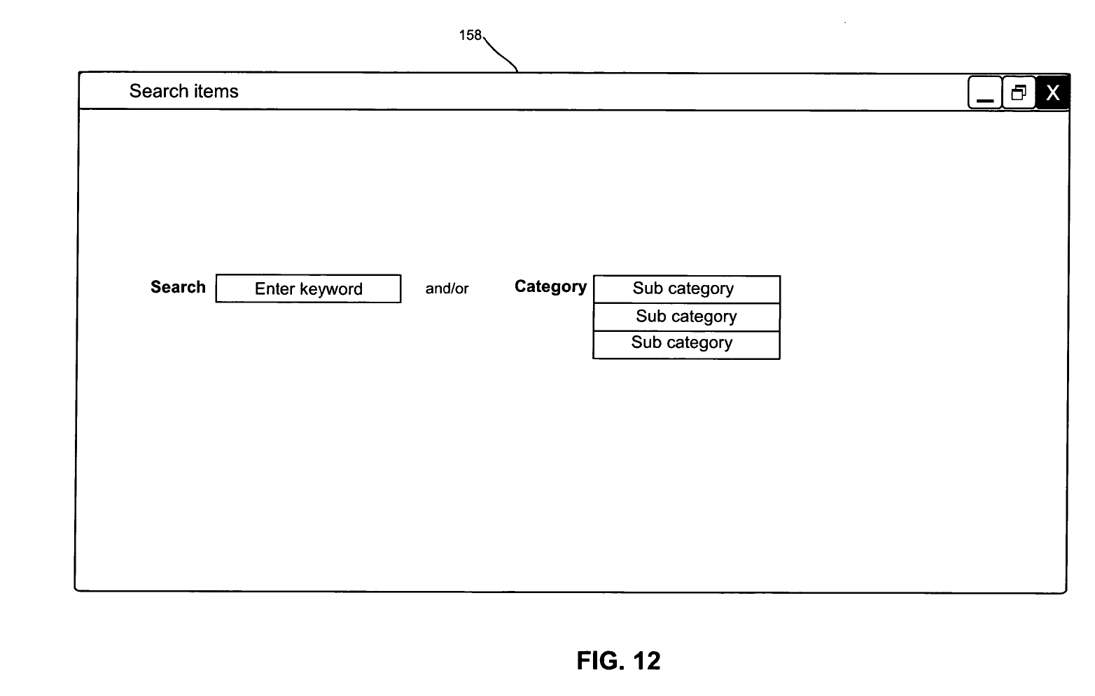

FIG. 12 illustrates a display screen 158 entitled “Search items” that is presented to a buyer on successful log in where user may search items for sale by entering a keyword in input text labeled “Search”. In addition, the user can refine the search by selecting a category and/or a subcategory from a drop down list labeled “Category.”

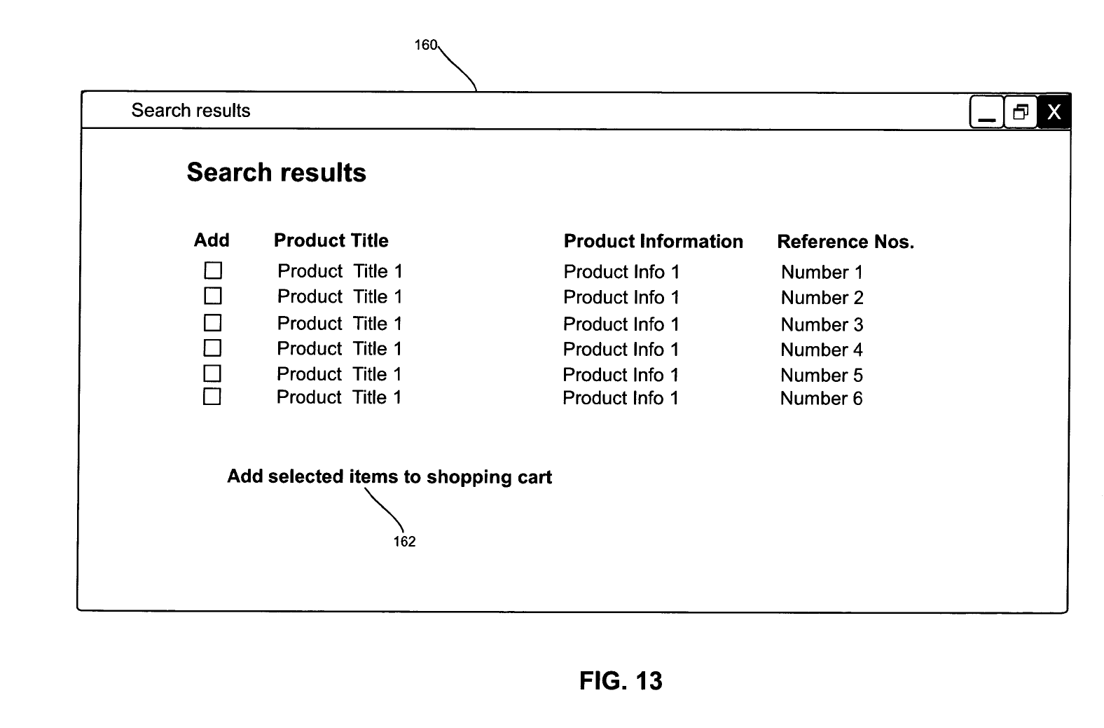

Referring to FIG. 13, a display screen 160 entitled “Search results” that generated on submission of search keyword and/or search category is illustrated where user can add items from search results to shopping cart. The user proceeds to adding items to shopping cart by clicking a button 162 designated as “Add selected items to shopping cart.”

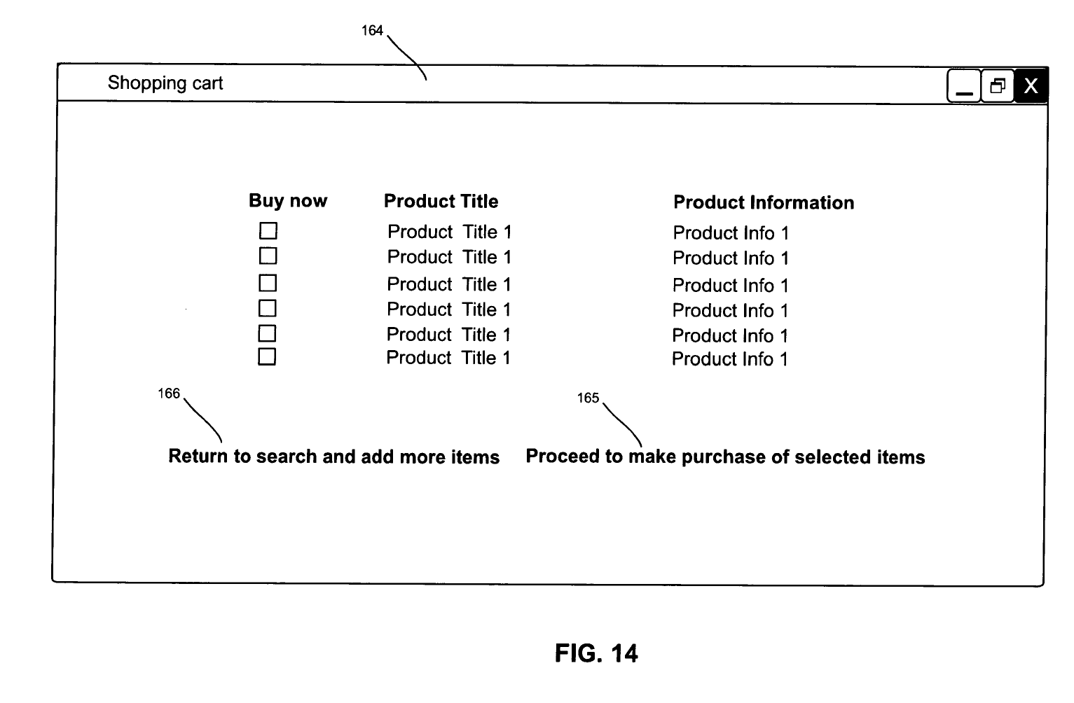

Referring to FIG. 14, a display screen 164 entitled “Shopping cart” generated upon clicking button 162 is illustrated where user may select items. The user proceeds to buying by clicking a button 165 designated as “Proceed to make purchase of selected items” or returns to searching adding more items to cart by clicking a button 166 designated as “Return to search and add more items.” to search and add more items.

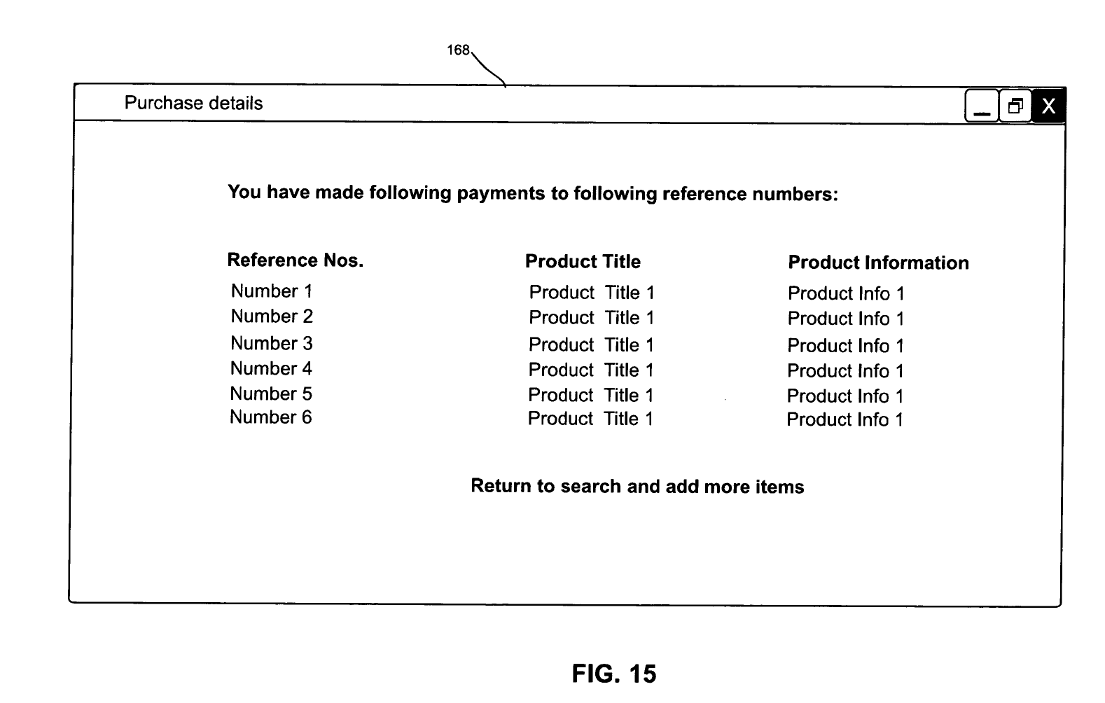

Referring to FIG. 15, a display screen 168 entitled “Purchase details” is generated upon clicking button 165. The purchasing process ends here. Here the user may return to searching and adding by clicking by clicking a button designated as “Return to search and add more details.”

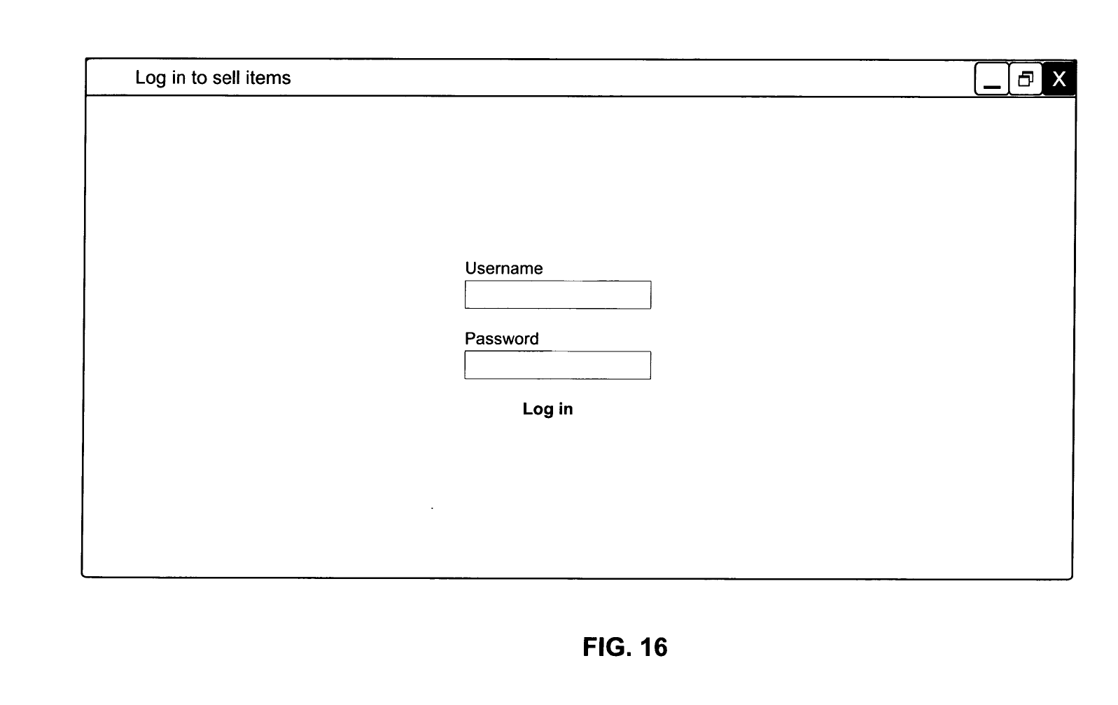

Referring now to FIGS. 16-19, the steps involved when a user posts new items for sale are explained. Referring to FIG. 16, a display screen 168 entitled “Log in to sell items” is illustrated where a user logs in to proceed to posting items for sale.

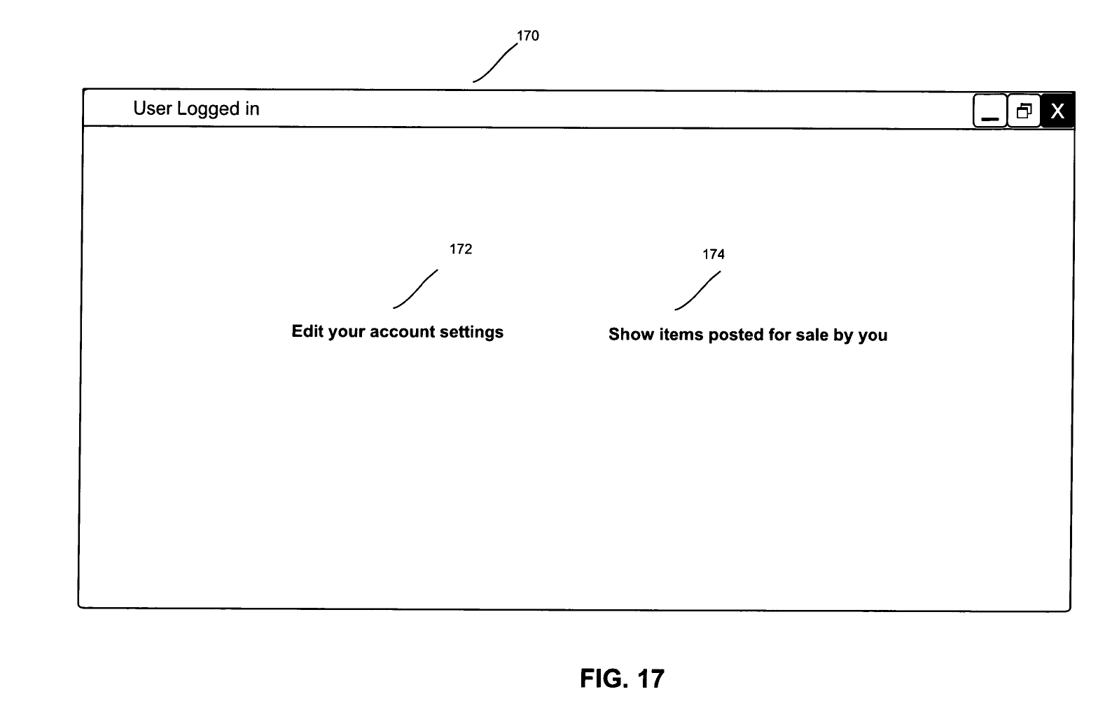

FIG. 17, illustrates a display screen 170 entitled “User logged in” that is generated when the user logs in where user may proceed to edit account settings by clicking on a button 172 designated as “Edit your account settings” or may proceed to get a display of items posted for sale by clicking a button 174 designated as “Show items posted for sale.”

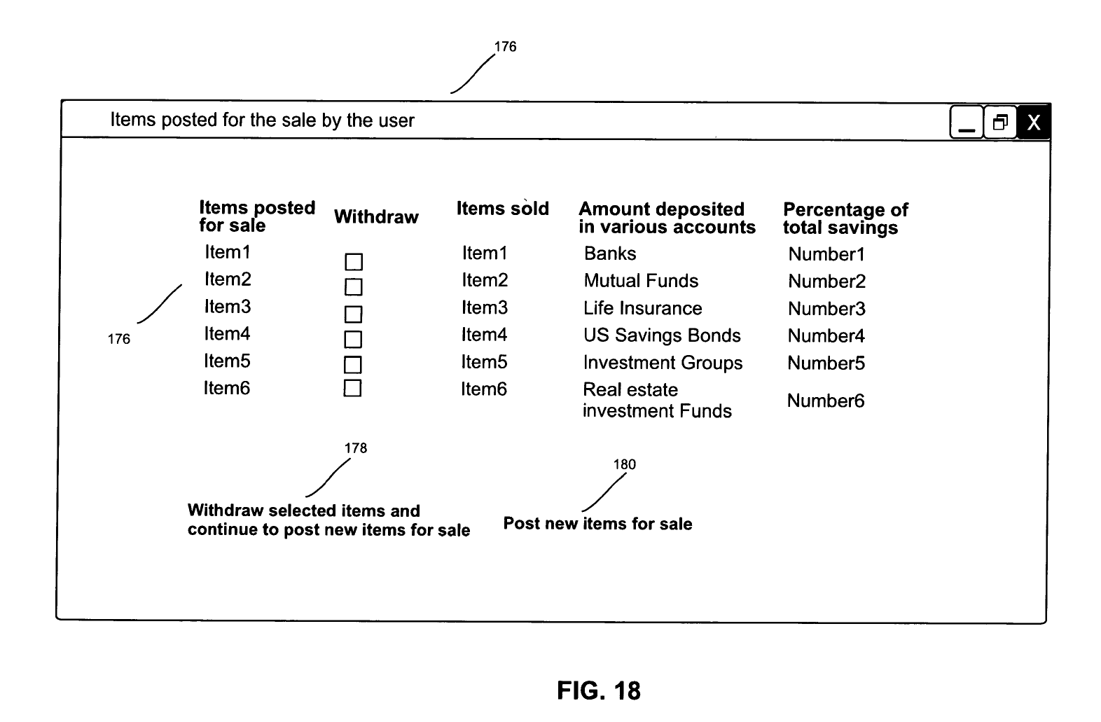

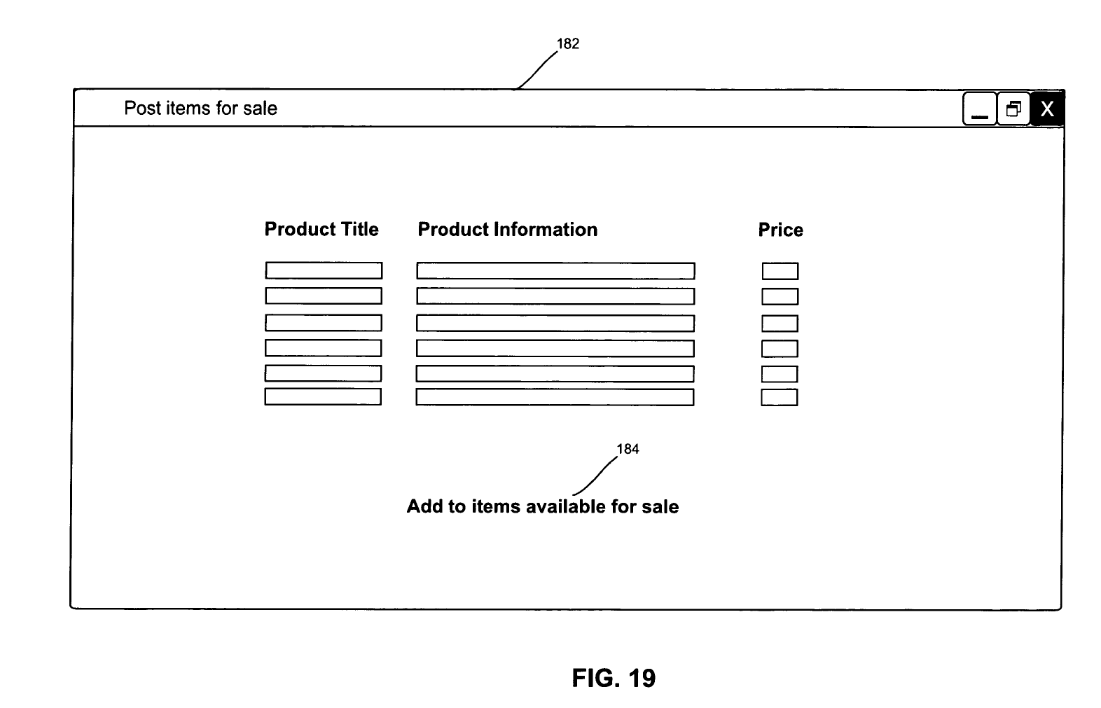

FIG. 18, illustrates a display screen 176 entitled “Items posted for the sale by the user” is generated upon clicking a button 174 where list of items posted for sale by user is displayed. Other lists such as items sold, amount deposited in various designated accounts are also displayed. The user may proceed to withdrawing and deleting the items by selecting choice boxes pertaining to the items to withdrawn. After selecting the items to be withdrawn user may continue posting new items by clicking a button designated as “Withdraw selected items and continue to post new items for sale.” The user may also proceed to posting new items without withdrawing any items by clicking a button designated as “Post new items for sale.” Either of these two options takes the user display screen 182 entitled “Post items for sale” illustrated in FIG. 19 where user can post new items by entering information such as, but not limited to, product title, product information and product price. The user may proceed to return adding more items by clicking a button designated as “Add items available for sale.”

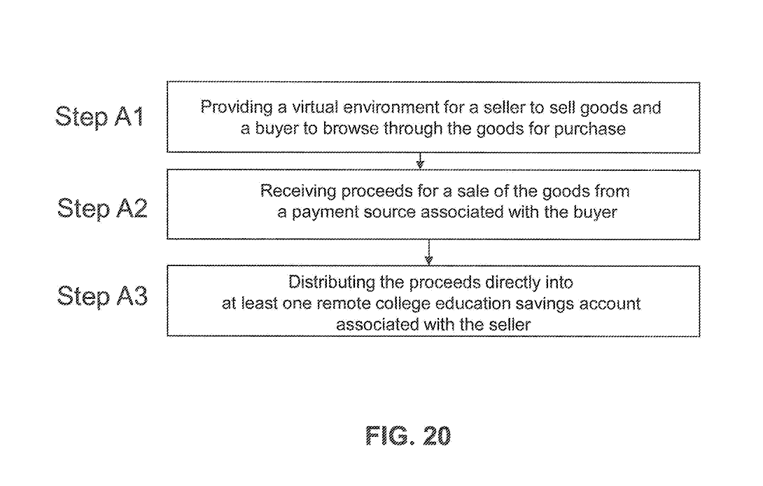

FIG. 20 shows a method for distributing proceeds from online sales into remote college education savings accounts. The system provides a virtual environment for a seller to sell goods and a buyer to browse through the goods for purchase. (STEP A1). After a sale is made, the system receives the proceeds from the sale from a payment source associated with the buyer. (STEP A2). The proceeds are directly distributed into a college education savings account associated with the seller. (STEP A3).

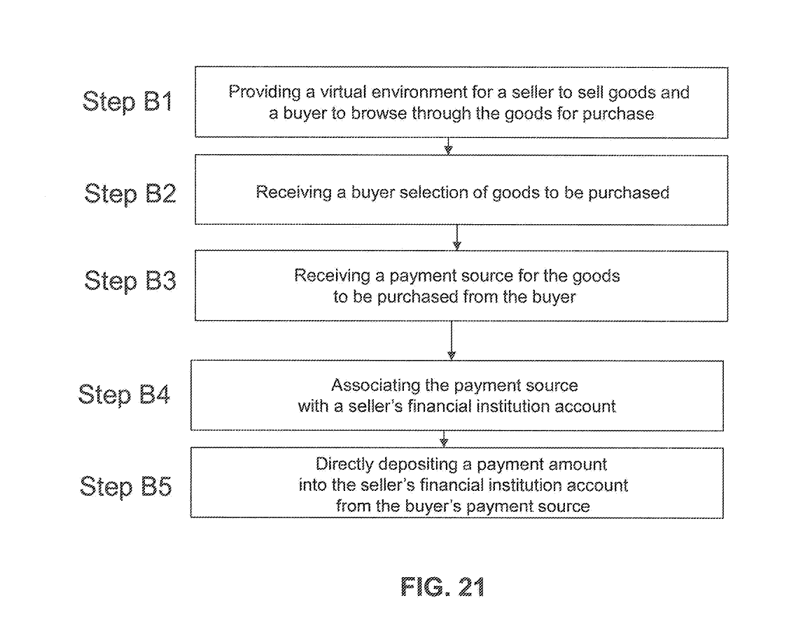

In another implementation, shown in FIG. 21, the system provides a virtual environment for a seller to sell goods and a buyer to browse through the goods for purchase. (Step B1). The goods can be associated with a private file, not available to the buyer, which associates the goods for sale with a financial institution of the seller's choosing. After a buyer selects the goods she wishes to purchase (Step B2), the buyer supplies the payment source to the online store. (Step B3). The online store associates the payment source with the seller's financial institution account. (Step B4). The buyer's payment is then directly deposited into the seller's account at financial institution. (Step B5). The online store does not hold any payments within their own system but can receive royalties from the transaction from the financial institution. These royalties can be contracted with beforehand.

In some implementations, the financial institution can receive a notification from the online store that includes who is sending the money, how much is to be received and what account the money should be deposited. The financial institution can then receive the payment and put the payment into a seller associated account. Once received, the financial institution can send a confirmation to the online store confirming the payment was received. The online store can then send a confirmation to the seller that the good have been paid for and shipment should be sent to buyer. The seller can send the goods. The buyer can wait for shipment and send a confirmation to the online store that the goods were received and can give a rating for the transaction at that time.

In some implementations, the remote college education savings accounts can be affiliated with a financial institution. In some implementations, the proceeds of the sale can be divided as designated by the seller and put into two or more remote college education savings accounts.

In some implementations, the system can also provide a searchable database listing types of college education savings accounts, provide links to financial institutions that offer college education accounts and provide incentives for opening college education accounts with certain financial institutions.

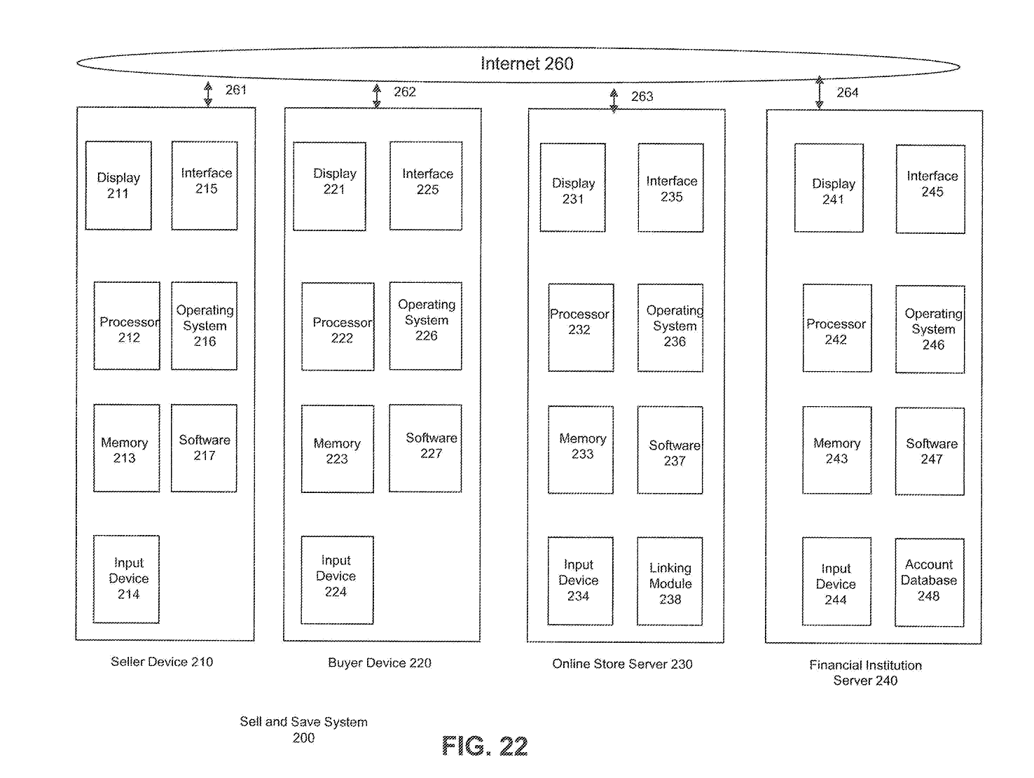

FIG. 22 is a schematic diagram of an example of a sell and save system 200. The sell and save system includes a seller device 210, a buyer device 220, an online store server 230 and a financial institution server 240. For ease of explanation only one of each device is shown but more than one of each is contemplated.

The seller device 210 includes a display 211, a processor 212, a memory 213, an input device 214, an interface 215, an operating system 216 and software 217.

The buyer device 220 includes a display 221, a processor 222, a memory 223, an input device 224, an interface 225, an operating system 226 and software 227.

The online store server 230 includes a display 231, sale software 232, a processor 233, a memory 234, an input device 235, an interface 236, an operating system 237 and linking module 238.

The financial institution server 240 includes a display 241, software 242, a processor 243, a memory 244, an input device 245, an interface 246, an operating system 247 and account database 248.

The devices 210, 220 and servers 230, 240 can be connected to one another over an internet connection 260 but more secure connections are contemplated.

In some implementations, the system of FIG. 22 can be split into a device-server environment communicatively connected over the internet 260 with connectors 261, 262, 263, 264 where the one or more servers 230, 240 include hardware as shown in FIG. 22 and also code for linking payment sources with seller accounts, code for generating notifications, and code for verifying transactions.

The operating systems 216, 226, 236, 246 can be multi-user, multiprocessing, multitasking, multithreading, real-time and the like. The operating systems 216, 226, 236, 246 may perform basic tasks, including but not limited to: recognizing input from input devices 214, 224, 234, 244; sending output to display devices 211, 221, 231, 241; keeping track of files and directories on computer-readable mediums 213, 223, 233, 243 (e.g., memory or a storage device); controlling peripheral devices (e.g., disk drives, printers, etc.); and managing traffic on the one or more buses 261, 262, 263, 264.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The foregoing Detailed Description is to be understood as being in every respect illustrative and exemplary, but not restrictive, and the scope of the disclosed technology disclosed herein is not to be determined from the Detailed Description, but rather from the claims as interpreted according to the full breadth permitted by the patent laws. It is to be understood that the embodiments shown and described herein are only illustrative of the principles of the disclosed technology and that various modifications may be implemented by those skilled in the art without departing from the scope and spirit of the disclosed technology. Those skilled in the art could implement various other feature combinations without departing from the scope and spirit of the disclosed technology. Although the embodiments of the present disclosure have been described with specific examples, it is to be understood that the disclosure is not limited to those specific examples and that various other changes, combinations and modifications will be apparent to one of ordinary skill in the art without departing from the scope and spirit of the disclosed technology which is to be determined with reference to the following claims.

What is claimed:

1. A method performed on a computer system for distributing proceeds from online sales into remote college education savings accounts, the method comprising:
providing a virtual environment for a seller to sell goods and a buyer to browse through the goods for purchase;
receiving proceeds for a sale of the goods from a payment source associated with the buyer; and
distributing the proceeds directly into at least one remote college education savings account associated with the seller.

2. The method of claim 1 wherein the remote college education savings accounts are affiliated with a financial institution.

3. The method of claim 1 wherein the proceeds can be divided as designated by the seller and put into two or more remote college education savings accounts.

4. The method of claim 1, the method further comprising:
providing a searchable database listing types and rankings of college education savings accounts.

5. The method of claim 1, the method further comprising:
providing links to financial institutions that offer college education accounts.

6. The method of claim 1, the method further comprising:
providing incentives for opening college education accounts with certain financial institutions.

7. A method performed on a computer system for distributing proceeds from online sales into remote college education savings accounts, the method comprising:
providing a virtual environment for a seller to sell goods and a buyer to browse through the goods for purchase;
receiving a purchase order and a payment source from the buyer;
linking the payment source to at least one remote college education savings account associated with the seller;
sending a note to a financial institution holding the at least one remote college education savings account that a payment of a certain sum is being sent for deposit into the at least one remote college education savings account; and
receiving a confirmation from the financial institution that the certain sum has been received.

8. The method of claim 7, the method further comprising:
sending a notification to the seller that the certain sum was deposited into the at least one remote college education savings account.

9. The method of claim 8, the method further comprising:
sending the goods to the buyer.

10. The method of claim 9, the method further comprising:
receiving a confirmation from the buyer that goods were received.
